(19) United States
(12) Patent Application Publication
(10) Pub. No.: US 2022/0312549 A1
(43) Pub. Date: Sep. 29, 2022

(54) SYSTEM AND METHOD OF WALKIE-TALKIE COMMUNICATION CROSSING WIRELESS FREQUENCY DOMAINS

(71) Applicant: Keenstar Corporation, Taipei City (TW)

(72) Inventors: Li-Wen LIAO, Taipei City (TW); Wan-Chen CHEN, Taipei City (TW); Ming-Chin HO, Taipei City (TW)

(21) Appl. No.: 17/215,096

(22) Filed: Mar. 29, 2021

(51) Int. Cl. H04W 76/45; H04W 4/10; H04W 72/04; H04B 1/44; H04W 72/00

(52) U.S. Cl. CPC H04W 76/45; H04W 4/10; H04W 72/0453; H04B 1/44; H04W 72/005

(57) ABSTRACT

The present invention discloses a system and a method of walkie-talkie communication crossing various wireless frequency domains. The system includes walkie-talkies, communication servers, and a connection network connecting the communication servers for mutual communication. The walkie-talkies are divided into communication groups, and each communication group is assigned to one specific communication server. The walkie-talkies and the communication server in the same communication group employ an exclusive wireless channel to wirelessly communicate. In particular, the communication server is invoked by one of the walkie-talkies in the same communication group to perform a broadcasting process for the walkie-talkies in different communication groups to broadcast at the same time. The present invention is suitably applied to any indoor or outdoor environments as long as the communication servers are provided. Additionally, it is easy for the use to learn how to correctly manipulate the walkie-talkie to invoke the broadcasting process without any confusion.

### BACKGROUND OF THE INVENTION

### 1. Field of the Invention

The present invention generally relates to a system and a method of walkie-talkie communication, and particularly to a system and a method of walkie-talkie communication crossing various wireless frequency domains, comprising walkie-talkies, communication servers, and a connection network, the walkie-talkies and the communication server assigned in the same communication group employing an exclusive wireless channel to communicate, the communication servers connected through the connection network for communication, the walkie-talkies further employed to invoke the communication servers to perform a broadcast process, thereby implementing the feature of broadcast over various wireless domains by single frequency walkie-talkie.

### 2. The Prior Arts

Recently, smart phones have had more powerful functions like talking, uploading/downloading electronic data, transferring text message, photos, and audio and video data, issuing commodities order, executing electronic payment, and implementing electronic business such that smart phones have become very popular for all ages of people, almost each person carrying one smart phone. In particular, people get used to carrying the smart phone outdoors, just like keys for home and car.

Although smart phones have become very popular, a lot of base stations in collocation with one another are needed to support communication quality as desired. Thus, if the base stations are not installed so closely as needed because of environmental issues for installation or protest of local residents, or wireless signal blocking by large obstacles like buildings or indoor construction material, the user of the walkie-talkie loses communication with other people. It is serious to lose communication for people.

To solve the above-mentioned problems, using walkie-talkies is one of the choices because walkie-talkies are light and easy to carry, and also have the key aspect of bi-directional wireless communication through a specific wireless channel. Thus, all the users can perform bi-directional speech communication, and particularly, the same wireless channel is available for a plurality of walkie-talkies to communicate. In contrast to the mobile phones failing to proceed communication due to poor signal quality, the traditional walkie-talkie becomes one of the best choices, especially in case of emergence. Additionally, for some remote places without available base stations or with only few base stations for mobile phones, like mountainous areas or desert regions, the walkie-talkie almost becomes the only option for communication. Furthermore, it is charge-free to use the walkie-talkies for communication, and the walkie-talkies are thus more economical and feasible for the users.

However, one of the drawbacks in the prior arts is that the traditional walkie-talkie only provides the same wireless channel for the other walkie-talkies to bi-directionally communicate to avoid interference and keep privacy. In other words, the user can not employ a different channel to communicate with other walkie-talkies. Once emergent or dangerous events occur, it fails to immediately inform all the users of the walkie-talkies to take urgent measures, or leave right now to avoid any potential danger

It is worth to mention that dual frequency and dual standby walkie-talkies provided with two communication channels have been available, and can simultaneously receive the voice from a first channel and a second channel. The dual frequency and dual standby walkie-talkie is provided with a first channel key and a second channel key for the user to select and switch to one of the two channels for communication with the same group or the other group. Somehow, such a technique is able to achieve communication over different wireless domains. Take 5 groups as an example. Each group employs the first channel as the individual group channel, two groups are provided with two different individual group channels, and the second channel is a common group channel for all the groups to receive. Thus, the user presses the first key to communicate with same group as internal broadcast, and the user can press the second key to broadcast to the other groups.

However, the above dual frequency and dual standby walkie-talkie has one drawback that no other options are available for the user except the first channel key and the second channel key. The overall performance is thus greatly limited. Also, in this case, to perform the wireless broadcasting over various groups, it would require the use of special dual frequency and dual standby walkie-talkie models, which the traditional single frequency walkie talkies would fail to partake.

Therefore, it is greatly needed to provide a new system and a method of walkie-talkie communication for crossing different wireless frequency domains, comprising walkie-talkies, communication servers, and a connection network, the walkie-talkies and the communication server assigned in the same communication group employing an exclusive wireless channel to communicate, the communication servers connected through the connection network for communication, the walkie-talkies further employed to invoke communication servers to perform the start a broadcast process, thereby implementing the feature of broadcast over various wireless domains by single frequency walkie-talkie, thereby overcoming the above problems in the prior arts.

### SUMMARY OF THE INVENTION

The primary objective of the present invention provides a system of walkie-talkie communication for implementing the feature of crossing different wireless frequency domains, comprising walkie-talkies, communication servers, and a connection network connecting the communication servers for communication.

The walkie-talkies are divided into a plurality of communication groups. In other words, each communication group is provided with at least one walkie-talkie. Further, each communication server is provided with a wireless communication function and assigned to one of communication groups.

Specifically, each walkie-talkie is provided with an exclusive wireless channel having a wireless frequency to communicate with the communication server and the other walkie-talkies of the same communication group. In particular, different wireless channels will each have different wireless frequency, and different communication groups are not capable of communicating with other communication groups through their exclusive wireless channels.

Additionally, the walkie-talkie is employed to perform a communication process comprising one of a talking mode and a receiving mode. In the talking mode, the walkie-talkie generates and transmits a talking signal comprising a talking content through the exclusive wireless channel, and in the receiving mode, the walkie-talkie receives the talking signal through the exclusive wireless channel and then plays and broadcasts the talking content to the other walkie-talkies of the same communication group.

Each communication server receives the talking signal from any of the walkie-talkies of the same communication group through the exclusive wireless channel. Also, the communication server employs the talking signal to perform a determination process.

The above determination process comprises: a step of checking the talking signal to determine if the talking signal meets a determination condition; generating a broadcasting start signal in case of the determination condition met by the talking signal; transmitting the broadcasting the start signal and the talking signal to the other communication servers through the connection network; each of the other communication servers receiving the broadcasting start signal and the talking signal, then inspecting if the broadcasting start signal meets a broadcasting condition, and performing a broadcasting process in case of the broadcasting condition met by the broadcasting start signal, the broadcasting process employing the exclusive wireless channel to transmit the talking signal to the walkie-talkies; and the walkie-talkies playing the talking content carried by the talking signal for a broadcasting time preset between 1 to 300 seconds, and then returning back to and repeating the step of checking the talking signal.

It is obvious that the system of walkie-talkie communication of the present invention providing the feature of crossing over different wireless frequency domains is simple as a whole, and it can be implemented by using traditional single frequency walkie-talkies and does not require special dual frequency dual standby walkie-talkie.

Additionally, another object of the present invention provides a method of walkie-talkie communication, comprising steps of S10, S20, S30, S40, and S50 for implementing the feature of crossing different wireless frequency domains.

In the step of S10, a plurality of walkie-talkies is provided and divided into a plurality of communication groups, and each communication group comprises at least one walkie-talkie.

In the step of S20, a plurality of communication servers is provided, each of the communication servers is assigned to one of the communication groups, each communication group has a communication server that is different from others', and the communication servers are connected together through a connection network comprising a wireless network or a wire network for communication.

Additional, the walkie-talkies and the communication server of the same communication group are allowed to communicate through an exclusive wireless channel having a wireless frequency. Any two exclusive wireless channels have two different wireless frequencies, and any two communication groups are not allowed to directly communicate with each other.

In the step of S30, the walkie-talkie is employed to perform a communication process, comprising one of a talking mode and a receiving mode. In the talking mode, a talking signal comprising a talking content is generated and transmitted through the exclusive wireless channel. In the receiving mode, the talking signal is received through the exclusive wireless channel and then the talking content is played and broadcasted to the other walkie-talkies of the same communication group.

In the step of S40, each of the communication servers receives the talking signal from any of the walkie-talkies of the same communication group through the exclusive wireless channel, and in the step of S50, the communication server employs the talking signal received to perform a determination process.

The above determination process generally comprises: a step of S60 of checking the talking signal to determine if the talking signal meets a determination condition; a step of S70, generating a broadcasting start signal in case of the determination condition met by the talking signal; a step of S80, transmitting the broadcasting the start signal and the talking signal to the other communication servers through the connection network; a step of S90, each of the other communication servers receiving the broadcasting start signal and the talking signal, then inspecting if the broadcasting start signal meets a broadcasting condition, and performing a broadcasting process in case of the broadcasting condition met by the broadcasting start signal, the broadcasting process employing the exclusive wireless channel to transmit the talking signal to the walkie-talkies; and a step of S95, the walkie-talkies playing the talking content carried by the talking signal for a broadcasting time, and then returning back to the step of S60.

For example, the above broadcasting time is preset between 1 to 300 seconds.

Therefore, the system and the method provided by the present invention can meet the user's habit or practice for the traditional walkie-talkies without any confusion as long as the communication servers being installed and connected, and is very suitable for any indoor and outdoor environments such as hospitals, department stores, large scale demonstration scenes, industrial districts, domestic guards, community security, mountaineers, polices, emergency searching teams, and even military troops.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the system of walkie-talkie communication crossing wireless frequency domains according to the first embodiment of the present invention;

FIG. 2 is a view showing the functional blocks of the walkie-talkie in the system according to the first embodiment of the present invention;

FIG. 3 is a flowchart of the method of walkie-talkie communication crossing wireless frequency domains according to the second embodiment of the present invention;

FIG. 4 is a flowchart of the determination process of the method according to the second embodiment of the present invention;

FIG. 5 is a view showing one determination condition of the method according to the second embodiment of the present invention; and

FIG. 6 is a view showing another determination condition of the method according to the second embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

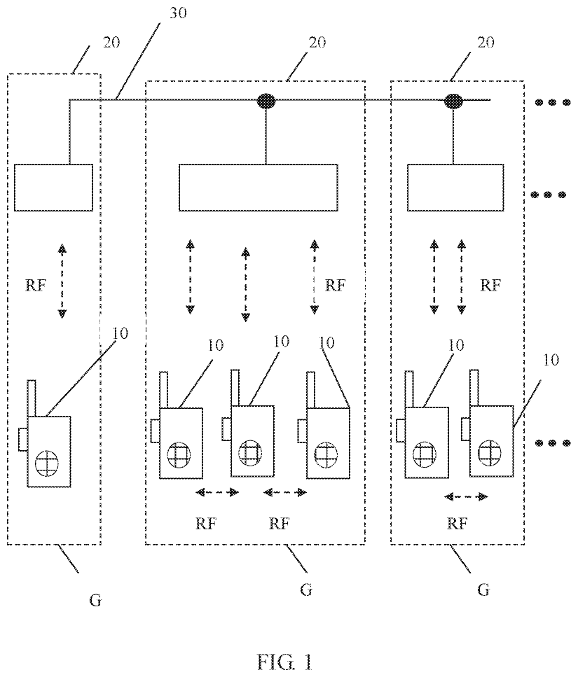

Please refer to FIG. 1 showing the system of walkie-talkie communication crossing wireless frequency domains according to the first embodiment of the present invention. As shown in FIG. 1, the system of walkie-talkie communication crossing wireless frequency domains according to the first embodiment of the present invention generally comprises a plurality of walkie-talkies 10, a plurality of communication servers 20, and a connection network 30 for implementing the feature of crossing different wireless frequency domains, suitably applied to particular or emergent situations.

Specifically, the above walkie-talkies 10 are divided into a plurality of communication groups G, each walkie-talkie 10 is provided with a wireless communication function, and each communication group G is provided with at least one walkie-talkie 10. It should be noted that three communication groups G are shown in FIG. 1 and specified by a first communication group, a second communication group, and a third communication group from left to right, respectively, wherein the first communication group comprises one walkie-talkie 10, the second communication group comprises three walkie-talkies 10, and the third communication group comprises two walkie-talkies 10. However, the above design is only an illustrative example for clear description of the aspects, and not intended to limit the scope of the present invention.

In addition, each communication server 20 is also provided with a wireless communication function, and assigned to one of the communication groups G. That is, a one-to-one relationship is established between the communication groups G. and the communication servers 20. Further, the communication servers 20 are connected through the connection network 30 for communication, and the connection network 30 may comprise a wireless network or a wire network.

In particular, each walkie-talkie 10 is provided with an exclusive wireless channel RF having a wireless frequency for the communication server 20 and the other walkie-talkies 10 of the same communication group G to communicate. In particular, different wireless channels RF will each have different wireless frequency, and different communication groups G are not capable of communicating with other communication groups G through their exclusive wireless channels RF. In other words, a one-to-one relationship is established between the exclusive wireless channels RF and the communication groups G.

More specifically, the walkie-talkie 10 is employed to perform a communication process comprising one of a talking mode and a receiving mode. For instance, the talking mode and the receiving mode are switched by pressing a specific key. That is, the communication process performed by the walkie-talkie 10 is the talking mode or the receiving mode, and does not execute the talking mode and the receiving mode at the same time.

In the talking mode, the walkie-talkie 10 generates and transmits a talking signal comprising a talking content through the exclusive wireless channel RF, and in the receiving mode, the walkie-talkie 10 receives the talking signal through the exclusive wireless channel RF and then plays and broadcasts the talking content to the other walkie-talkies 10 of the same communication group G. Thus, any walkie-talkie 10 in the talking mode is intended for the user to broadcast the talking content to the other walkie-talkies 10 of the same communication group G, and any walkie-talkie 10 in the receiving mode is able to receive and play the talking content for the user to listen, thereby implementing the wireless communication function.

Further, each communication server 20 employs the exclusive wireless channel RF assigned to the communication group G to constantly receive any talking signal transmitted by the other walkie-talkies 10 of the same communication group G, and perform a determination process based on the talking signal received.

The above determination process comprises: a step of checking the talking signal to determine if the talking signal meets a determination condition; generating a broadcasting start signal in case of the determination condition met by the talking signal; transmitting the broadcasting the start signal and the talking signal to the other communication servers through the connection network; each of the other communication servers receiving the broadcasting start signal and the talking signal, then inspecting if the broadcasting start signal meets a broadcasting condition, and performing a broadcasting process in case of the broadcasting condition met by the broadcasting start signal, the broadcasting process employing the exclusive wireless channel to transmit the talking signal to the walkie-talkies; and the walkie-talkies playing the talking content carried by the talking signal for a broadcasting time preset between 1 to 300 seconds, and then returning back to and repeating the step of checking the talking signal.

Additionally, the walkie-talkies 10 of the present invention are implemented by traditional walkie-talkies, and only the primary features about the walkie-talkies 10 are thus briefly described hereinafter for reference.

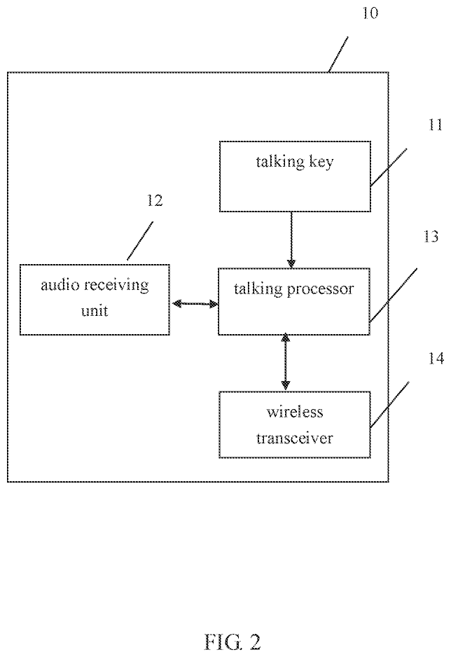

Further refer to FIG. 2 illustrating the functional blocks of the walkie-talkie 10 in the system according to the first embodiment of the present invention. As shown in FIG. 2, the walkie-talkie 10 comprises a talking key 11, an audio receiving unit 12, a talking processor 13, and a wireless transceiver 14.

The talking key 11 is intended for the user to press. When the talking key 11 is pressed, a key signal is generated and transmitted, and when the talking key 11 is released, the key signal is immediately not generated and stops. The audio receiving unit 12 is intended for receiving the talking content spoken out by the user to generate and transmit an audio signal. The talking processor 13 is electrically connected to the talking key 11 and the audio receiving unit 12 for receiving the key signal and the audio signal. More specifically, when the talking key 11 is pressed and the key signal is generated, the talking processor 13 executes the talking mode to convert the audio signal into the talking signal, and further transmit the talking signal. Also, when the talking key 11 is released, the talking processor 13 executes the receiving mode.

The wireless transceiver 14 is electrically connected to the talking processor 13 for receiving the talking signal from the talking processor 13 and transmitting the talking signal received through the exclusive wireless channel RF when the talking processor 13 is in the talking mode. In addition, when the talking processor 13 is in the receiving mode, the wireless transceiver 14 receives the talking signal from the other walkie-talkies 10 through the exclusive wireless channel RF and transmits the talking signal received to the talking processor 13, and the talking processor 13 further transmits the talking signal received to the wireless transceiver 14 for playing the talking content carried by the talking signal.

Overall, the system of walkie-talkie communication crossing wireless frequency domains according to the first embodiment of the present invention primarily provides the communication servers 20 for the walkie-talkies 10 to implement the broadcasting and playing function of crossing different wireless frequency domains. In other words, when the user employs any walkie-talkie 10 to invoke the corresponding communication server 20 to perform the broadcast process, the subsequent talking content spoken by the user is directly transmitted by the corresponding communication server 20 to the other communication servers 20, and the other communication servers 20 further transmit the subsequent talking content to the corresponding walkie-talkies 10 to play. It is thus equivalent that any walkie-talkie 10 is able to force all the other walkie-talkies 10 to play and broadcast the subsequent talking content.

The above determination condition can be implemented by the following illustrative measures.

For example, the determination condition may comprise: a silence time during a determination time is equal to or greater than a silence time limit, wherein the determination time is not larger than 60 seconds, and the silence time refers to a period of time when the talking content is continuously silent. For instance, the silence time limit is preset between 2 and 10 seconds. That is, when the user presses the talking key 11 of the walkie-talkie 10 and keeps silent over 2 seconds, the corresponding communication server 20 is invoked to perform the broadcast process.

Another example is that the determination condition may comprise: a silence time during a determination time is within a silence time range of group broadcast, wherein the determination time is not larger than 60 seconds, the silence time refers to a period of time when the talking content is continuously silent, and the silence time range of group broadcast refers to a preset silence time for the communication group. Particularly, the silence time range is within an upper time limit and a lower time limit. For instance, the upper time limit is 2 seconds and the lower time limit is 10 seconds for the first communication group, and the upper time limit is 11 seconds and the lower time limit is 20 seconds for the second communication group. When the silence time is 8 seconds, only the walkie-talkies 10 assigned to the first communication group are forced to broadcast, and when the silence time is 15 seconds, only the walkie-talkies 10 assigned to the second communication group are forced to broadcast. Therefore, it is practically easy and simple for the user to operate without any confusion.

Overall, when the user of the specific walkie-talkie 10 thinks it is time to broadcast to all the walkie-talkies 10 of the other communication servers 20, the user may employs the specific walkie-talkie 10 to invoke the corresponding communication server 20 to perform the broadcast process and transmit the broadcast start signal to inform the other communication servers 20 to pass the talking content to the walkie-talkies 10. In other words, the user employs the specific walkie-talkie 10 to broadcast to all the walkie-talkies 10, thereby implementing the communication feature for the walkie-talkies 10 crossing different communication domains.

Furthermore, an yet example is that the determination condition may comprise: a silence number during a determination time is within a silence number range, the determination time is not larger than 30 seconds, the silence number refers to a number as how many times when the talking content is continuously silent and lasts for not less than an effective silence time, the effective silence time is preset between 0.5 and 3 seconds, and the silence number range refers to a broadcast determination number preset for the communication group. For instance, if the broadcast determination number of the first communication group is 1, the broadcast determination number of the second communication group is 2, and the broadcast determination number of the third communication group is also 2, the user may continuously press the talking key 11 of the walkie-talkie 10 of the first communication group two times, each time 2 seconds, and then employs the walkie-talkie 10 to broadcast the subsequent talking content to all the walkie-talkies 10 of the second and third communication groups at the same time. Also, the user may press the talking key 11 of the walkie-talkie 10 of the second of third communication group just one time, and then broadcast the subsequent talking content to all the walkie-talkies 10 of the first communication group. It is sure that the broadcast determination number specified for each communication group is flexibly preset as desired in actual applications.

Furthermore, an additional example is that the determination condition may comprise: the talking content matches a speech identification content through a speech identification process, wherein the determination time is not larger than 30 seconds, and the speech identification content comprises a set of key words. For instance, the set of key words comprises at least of a set of broadcast words, a set of group names, and a set of group codes, each of the group names referring to a name of the corresponding communication group, each of the group codes referring to a code of the corresponding communication group. In other words, the user just employs the walkie-talkie 10 to speak out the set of key words, and then all walkie-talkies 10 play the subsequent talking content of the user. For instance, the user speaks out “broadcast to the fifth communication group” meeting the set of key words, and the walkie-talkies 10 of the fifth communication group play the subsequent talking content of the user. Or alternatively, the user speaks out “broadcast to the second communication group, the third communication group, and the fourth communication group” meeting the set of key words, and the walkie-talkies 10 of the second, third, and fourth communication groups then play the subsequent talking content of the user at the same time. Furthermore, the user may speak out t “broadcast to all communication groups” meeting the set of key words, and the walkie-talkies 10 of the communication groups play the subsequent talking content of the user at the same time, thereby overall broadcasting.

Thus, the traditional walkie-talkies are able to achieve wireless communication crossing wireless frequency domains, as long as being in collocation with the communication servers of the present invention, and it is not needed to specifically modify the traditional walkie-talkies or additionally design a new walkie-talkie. Since the overall system of the present invention is simple to establish by use of traditional walkie-talkies, the user would not change familiar practice. Especially, the communication servers are easy to invoke and perform the broadcast process, and it is feasible for the user to correctly operate without any tough learning course.

More particularly, for the communication group G comprising only one walkie-talkie 10, the walkie-talkie 10 is just employed to communicate with the communication server 20 assigned, and the communication server 20 is intended to perform the determination process by checking the talking content. In other words, the only function of the walkie-talkie 10 is provided for the user to broadcast the subsequent talking content to at least one of the other communication groups.

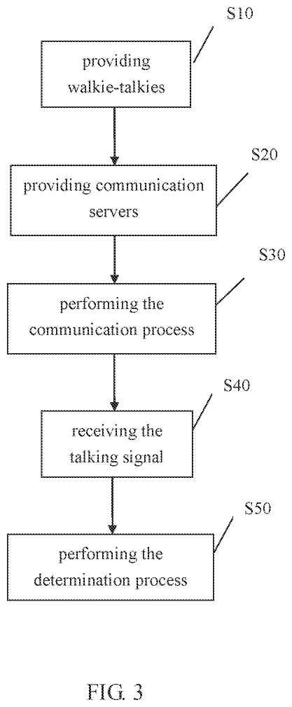

Further refer to FIG. 3 illustrating the flowchart of the method of walkie-talkie communication crossing wireless frequency domains according to the second embodiment of the present invention. As shown in FIG. 3, the method of walkie-talkie communication according to the second embodiment generally comprises steps of S10, S20, S30, S40, and S50 for implementing the feature of crossing different wireless frequency domains.

First, the method of walkie-talkie communication begins at the step of S10. A plurality of walkie-talkies is provided and divided into a plurality of communication groups, each of the communication groups comprising at least one walkie-talkie selected from the walkie-talkies, each of the walkie-talkies provided with a wireless communication function. Specifically, each of the communication groups is provided with an exclusive wireless channel having a wireless frequency for the walkie-talkies of the same communication group to communicate. In particular, different wireless channels will each have different wireless frequency, and different communication groups are not capable of communicating with other communication groups through their exclusive wireless channels.

Then in the step of S20, a plurality of communication servers is provided and divided into the communication groups, each of the communication servers assigned to one of the communication groups, and each communication group has a communication server that is different from others'. Additionally, all the communication servers are connected together through a connection network comprising a wireless network or a wire network for communication. In particular, the walkie-talkies and the communication server of the same communication group are allowed to communicate through the exclusive wireless channel. Any two exclusive wireless channels have two different wireless frequencies, and any two communication groups are not allowed to directly communicate with each other. In other words, different wireless channels will each have different wireless frequency, and different communication groups are not capable of communicating with other communication groups through their exclusive wireless channels.

The step of S30 is subsequently executed, and the walkie-talkie is employed by the user to perform a communication process comprising one of a talking mode and a receiving mode. Specifically, the walkie-talkie operating in the talking mode generates and transmits a talking signal comprising a talking content through the exclusive wireless channel, and the walkie-talkie operating in the receiving mode receives the talking signal through the exclusive wireless channel and then further plays and broadcasts the talking content to the other walkie-talkies of the same communication group.

Then the method of walkie-talkie communication enters the step of S40, and each of the communication servers receives the talking signal from any of the walkie-talkies of the same communication group through the exclusive wireless channel, and the step of S50 is performed, the communication server employing the talking signal received to perform a determination process.

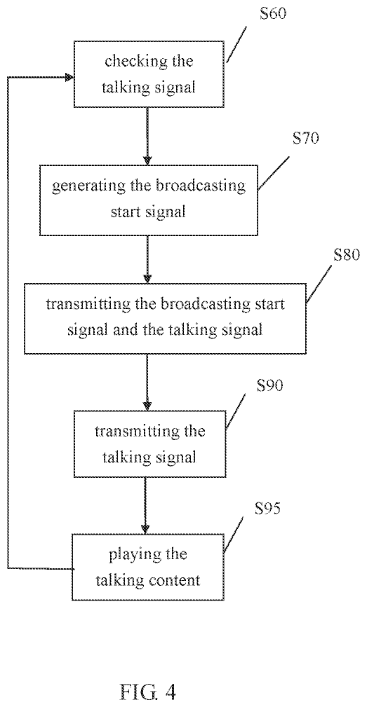

More specifically, the determination process comprises sequential steps of S60, S70, S80, S90, and S95 as shown in FIG. 4. In the step of S60, the talking signal is checked to determine if the talking signal meets a determination condition. The determination condition may comprise that the talking content is silence and lasts for more than a silence determination time preset, or that a talking number during a number determination time reaches or exceeds a talking determination number. For example, the silence determination time is between 5 and 10 seconds, the number determination time is equal to or less than 2 seconds, and the talking determination number is 2, 3, or 4.

In the step of S70, the communication server generates a broadcasting start signal when the determination condition is met by the talking signal, and then in the step of S80, the broadcasting start signal and the subsequent talking signal are transmitted to the other communication servers through the connection network.

The step of S90 is performed, and each of the other communication servers receives the broadcasting start signal and the talking signal, and then inspects if the broadcasting start signal meets a broadcasting condition. If the broadcasting condition is met by the broadcasting start signal, a broadcasting process is performed to employ the exclusive wireless channel to transmit the talking signal to the walkie-talkies. Finally in the step of S95, the walkie-talkies plays the talking content carried by the talking signal for a broadcasting time, and then returns back to the step of S60 for repeating the determination process. For example, the broadcasting time is preset between 1 to 300 seconds.

The above walkie-talkie is implemented by a traditional walkie-talkie, and may comprise a talking key, an audio receiving unit, a talking processor, and a wireless transceiver as an example.

The talking key is intended for the user to press. When the talking key is pressed, a key signal is generated and transmitted, and when the talking key is released, the key signal is immediately not generated and stops. The audio receiving unit is intended for receiving the talking content spoken out by the user to generate and transmit an audio signal. Additionally, the talking processor is electrically connected to the talking key and the audio receiving unit for receiving the key signal and the audio signal.

When the talking key is pressed and the key signal is generated, the talking processor executes the talking mode to convert the audio signal into the talking signal, and further transmit the talking signal. Also, when the talking key is released, the talking processor executes the receiving mode. The wireless transceiver is electrically connected to the talking processor for receiving the talking signal from the talking processor and transmitting the talking signal received through the exclusive wireless channel when the talking processor is in the talking mode. In addition, when the talking processor is in the receiving mode, the wireless transceiver receives the talking signal from the other walkie-talkies through the exclusive wireless channel and transmits the talking signal received to the talking processor, and the talking processor further transmits the talking signal received to the wireless transceiver for playing the talking content carried by the talking signal.

Furthermore, the above determination condition comprises: a silence time during a determination time is within a silence time range of group broadcast, the determination time is not larger than 60 seconds, the silence time refers to a period of time when the talking content is continuously silent, and the silence time range of group broadcast refers to a preset silence time for the communication group, and is within an upper time limit and a lower time limit.

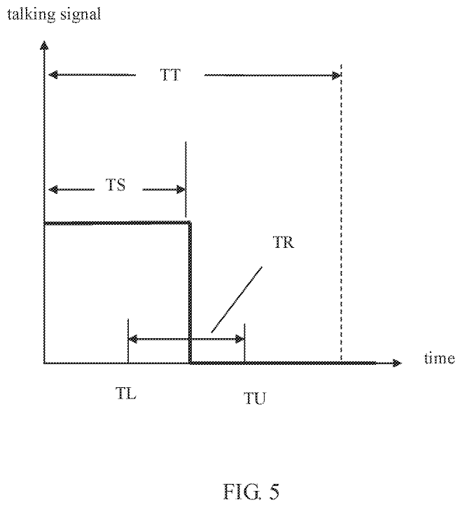

As shown in FIG. 5, when the silence time TS is within the upper time limit TU and the lower time limit TL assigned for the silence time range TR of group broadcast during the determination time TT, the walkie-talkies of the communication groups provided with the silence time range TR of group broadcast are forced to receive the talking signal transmitted by the corresponding communication servers and play the talking content carried by the talking signal, thereby implementing the broadcasting feature of crossing different wireless frequency domains. In other words, any two communication groups are allowed to provide with two different silence time ranges of group broadcast, or one silence time range of group broadcast is allowed to assign to more than one communication group. It is obvious that the practical measures are versatile and flexible to meet all kinds of application fields with more complicated and various combinations.

Another determination condition comprises: a silence number during a determination time is within a silence number range, the determination time is not larger than 30 seconds, the silence number refers to a number as how many times when the talking content is continuously silent and lasts for not less than an effective silence time, the effective silence time is preset between 0.5 and 3 seconds, and the silence number range refers to a broadcast determination number preset for the communication group.

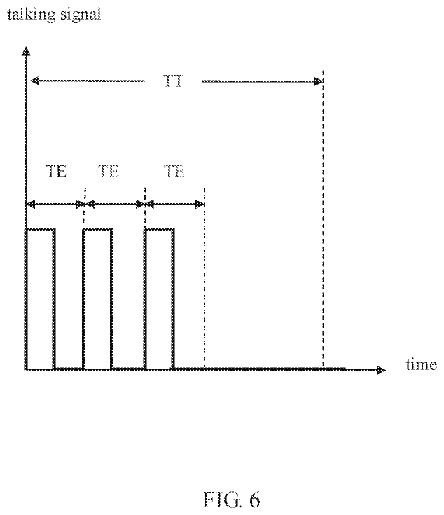

As shown in FIG. 6, the talking signal indicates that the user repeats three times to press and then release the talking key during the determination time TT, and each time when the talking key is pressed, the user keeps silent for a period of time not less than the effective silence time TE. Thus, the silence number is three. At this time, if the second, third, and fourth communication groups are designed to invoke to perform the broadcasting process only when the silence number is three, the communication servers of the second, third, and fourth communication groups transmit the talking signal to the walkie-talkies to play the talking content, thereby implementing the broadcasting feature of crossing different wireless frequency domains.

Further, a yet determination condition comprises: the talking content matches a speech identification content through a speech identification process, and the determination time is not larger than 30 seconds. The speech identification content comprises a set of key words. For instance, the set of key words comprises at least of a set of broadcast words, a set of group names, and a set of group codes. Therefore, the user can just employ the walkie-talkie to clearly speak out the talking content to specify at least one communication group to broadcast like “broadcast to the first communication group”, or “broadcast to the first communication group, the second communication group, and the third communication group”. It is obvious that the user may flexibly preset the set of key words for actual applications, or add any familiar key words to the set of set of key words according to usual practice, or combine various key words to establish the set of set of key words as a more complicated and effective command for the user to operate.

It is sure that the determination condition may also simply comprise: a silence time during a determination time is equal to or greater than a silence time limit, wherein the determination time is not larger than 60 seconds, and the silence time refers to a period of time when the talking content is continuously silent. For instance, the silence time limit is preset between 2 and 10 seconds. That is, when the user presses the talking key of the walkie-talkie and keeps silent over 2 seconds, the corresponding communication server is invoked to perform the broadcast process.

Furthermore, if the present invention is applied to a factory region having a plurality of petroleum factories, each of the workers at the factory or around the factory is provided with the wireless walkie-talkie to communicate through the exclusive wireless channel. In other word, any worker is able to talk with and listen to any other workers assigned to the same factory. In addition, to avoid interfering with the workers of the other factories, any two exclusive wireless channels are different like having two different wireless frequencies. Once an urgent event happens at the factory or around the factory like fire or harmful gas leakage, any worker can use the wireless walkie-talkie to broadcast and inform the workers in the factory region to keep away the factory, or immediately evacuate from the factory region.

Take restaurant as an example. All employee of the restaurant are divided into four communication groups, and each employee is provided with a wireless walkie-talkie. Under the normal condition, every employee of the communication group uses the wireless walkie-talkie to communicate with the other employee of the same communication group without interfering with the employee of the other communication groups. However, when an abnormal event or emergency occurs, such as a plate just broken to pieces on the floor and the dishes spreading out, it is necessary to inform all or part of the employee to take notice this situation. The employee who first finds this event is able to use the wireless walkie-talkie to broadcast and inform the employee of the same communication group and the other communication groups.

It is sure that the present invention is applicable to hospitals, department stores, large scale demonstration scenes, industrial districts, domestic guards, community security, mountaineers, polices, emergency searching teams, and even military troops. In other words, the application field of the present invention substantially covers indoor and outdoor environments as long as the communication servers are installed.

As mentioned above, one aspect provided by the present invention is that the communication servers are provided and each communication server is assigned to one corresponding communication group and provided with at least one traditional wireless walkie-talkie. In particular, the communication server constantly receives the talking signal from any wireless walkie-talkie of the same communication group, and determines if the talking signal meets the preset condition. When the preset condition is met, the broadcasting process is invoked to generate and transmit the broadcasting start signal to some specific communication servers or all the communication servers, and at the same time passes the talking signal to the other communication servers, thereby broadcasting to all the wireless walkie-talkies and implementing the feature of walkie-talkie communication crossing wireless frequency domains.

In addition, another aspect provided by the present invention is that the determination condition is simple and effective for the user to implement and the communication server employs the determination condition to determine whether to perform the broadcasting process. In particular, the determination condition comprises that the talking content is silent and lasts for more than the silence determination time. For example, the user intentionally presses the talking key but keeps silent for a long time. Since the talking key is pressed without speaking any words for a long time is an abnormal situation for usual practice of wireless walkie-talkie, and considered as a specific event intended to invoke the broadcasting process. Thus, the specific event does not interfere with normal operation of wireless walkie-talkie for the user. Or alternatively, the determination condition is the talking number during the number determination time reaches or exceeds the talking determination number. For example, the user fast presses the talking key of the wireless walkie-talkie two or tree times, and accordingly, fast pressing the talking key many times is not normal for usual operation, and is thus suitably considered as another specific event intended to invoke the broadcasting process. Thus, the user will not be confused. That is, the user just needs simple practice to correctly operate the whole process of broadcasting over different wireless frequency domains.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system of walkie-talkie communication crossing wireless frequency domains, comprising:
a plurality of walkie-talkies divided into a plurality of communication groups, each of the communication groups comprising at least one of the walkie-talkies, each of the walkie-talkies provided with a wireless communication function;
a plurality of communication servers, each of the communication servers provided with a wireless communication function and assigned to one of the communication groups, each of the communication groups comprising one of the communication servers and at least one of the walkie-talkies; and
a connection network, comprising a wireless network or a wire network to connect the plurality of communication servers for communication,
wherein each of the walkie-talkies is provided with an exclusive wireless channel having a wireless frequency to communicate with the communication server and the other walkie-talkies of the same communication group, different wireless channels have different wireless frequency, different communication groups are not capable of communicating with other communication groups through their exclusive wireless channels, the walkie-talkie is employed to perform a communication process comprising one of a talking mode and a receiving mode, the walkie-talkie operating in the talking mode generates and transmits a talking signal comprising a talking content through the exclusive wireless channel, the walkie-talkie operating in the receiving mode receives the talking signal through the exclusive wireless channel and then plays and broadcasts the talking content to the other walkie-talkies of the same communication group, and the communication server receives the talking signal from any of the walkie-talkies of the same communication group through the exclusive wireless channel to perform a determination process comprising:
a step of checking the talking signal to determine if the talking signal meets a determination condition;
generating a broadcasting start signal in case of the determination condition met by the talking signal;
transmitting the broadcasting the start signal and the talking signal to the other communication servers through the connection network;
each of the other communication servers receiving the broadcasting start signal and the talking signal, then inspecting if the broadcasting start signal meets a broadcasting condition, and performing a broadcasting process in case of the broadcasting condition met by the broadcasting start signal, the broadcasting process employing the exclusive wireless channel to transmit the talking signal to the walkie-talkies; and
the walkie-talkies playing the talking content carried by the talking signal for a broadcasting time preset between 1 to 300 seconds, and then returning back to and repeating the step of checking the talking signal.

2. The system as claimed in claim 1, wherein the walkie-talkie comprises:
a talking key for an user to press, a key signal generated and transmitted when the talking key pressed, and the key signal not generated when the talking key released;
an audio receiving unit for receiving the talking content spoken out by the user to generate and transmit an audio signal;
a talking processor electrically connected to the talking key and the audio receiving unit for receiving the key signal and the audio signal, the talking mode performed by the talking processor when the talking key pressed and the key signal generated, the receiving mode performed by the talking processor when the talking key released, the talking processor in the talking mode converting the audio signal into the talking signal, and transmitting the talking signal; and
a wireless transceiver electrically connected to the talking processor for receiving the talking signal from the talking processor and transmitting the talking signal received through the exclusive wireless channel when the talking processor operating in the talking mode, or receiving the talking signal from the other walkie-talkies through the exclusive wireless channel and transmitting the talking signal received to the talking processor when the talking processor operating in the receiving mode, the talking processor receiving the talking signal from the wireless transceiver and further transmitting the talking signal received to the audio receiving unit for playing the talking content carried by the talking signal.

3. The system as claimed in claim 1, wherein the determination condition comprises: a silence time during a determination time is within a silence time range of group broadcast, the determination time is not larger than 60 seconds, the silence time refers to a period of time when the talking content is continuously silent, and the silence time range of group broadcast refers to a preset silence time for the communication group, and is within an upper time limit and a lower time limit.

4. The system as claimed in claim 1, wherein the determination condition comprises: a silence number during a determination time is within a silence number range, the determination time is not larger than 30 seconds, the silence number refers to a number as how many times when the talking content is continuously silent and lasts for not less than an effective silence time, the effective silence time is preset between 0.5 and 3 seconds, and the silence number range refers to a broadcast determination number preset for the communication group.

5. The system as claimed in claim 1, wherein the determination condition comprises: the talking content matches a speech identification content through a speech identification process, the determination time is not larger than 30 seconds, the speech identification content comprises a set of key words, and the set of key words comprises at least of a set of broadcast words, a set of group names, and a set of group codes, each of the group names referring to a name of the corresponding communication group, each of the group codes referring to a code of the corresponding communication group.

6. A method of walkie-talkie communication crossing wireless frequency domains, comprising:
a step of S10, providing and dividing a plurality of walkie-talkies into a plurality of communication groups, each of the communication groups comprising at least one walkie-talkie selected from the walkie-talkies, each of the walkie-talkies provided with a wireless communication function;
a step of S20, providing a plurality of communication servers, each of the communication servers assigned to one of the communication groups, each communication group having a communication server different from others', the communication servers connected together through a connection network comprising a wireless network or a wire network for communication, each of the communication groups provided with an exclusive wireless channel having a wireless frequency for the walkie-talkies and the communication server of the same communication group to communicate, different wireless channels having different wireless frequency, different communication groups not capable of communicating with other communication groups through their exclusive wireless channels;
a step of S30, the walkie-talkie employed to perform a communication process comprising one of a talking mode and a receiving mode, the walkie-talkie operating in the talking mode generating and transmitting a talking signal comprising a talking content through the exclusive wireless channel, the walkie-talkie operating in the receiving mode receiving the talking signal through the exclusive wireless channel and then playing and broadcasting the talking content to the other walkie-talkies of the same communication group;
a step of S40, each of the communication servers receiving the talking signal from any of the walkie-talkies of the same communication group through the exclusive wireless channel; and
a step of S50, the communication server employing the talking signal received to perform a determination process comprising:
a step of S60 of checking the talking signal to determine if the talking signal meets a determination condition;
a step of S70, generating a broadcasting start signal in case of the determination condition met by the talking signal;
a step of S80, transmitting the broadcasting start signal and the talking signal to the other communication servers through the connection network;
a step of S90, each of the other communication servers receiving the broadcasting start signal and the talking signal, then inspecting if the broadcasting start signal meets a broadcasting condition, and performing a broadcasting process in case of the broadcasting condition met by the broadcasting start signal, the broadcasting process employing the exclusive wireless channel to transmit the talking signal to the walkie-talkies; and
a step of S95, the walkie-talkies playing the talking content carried by the talking signal for a broadcasting time, and then returning back to the step of S60, the broadcasting time preset between 1 to 300 seconds.

7. The method as claimed in claim 6, wherein the walkie-talkie comprises:
a talking key for an user to press, a key signal generated and transmitted when the talking key pressed, and the key signal not generated when the talking key released;
an audio receiving unit for receiving the talking content spoken out by the user to generate and transmit an audio signal;
a talking processor electrically connected to the talking key and the audio receiving unit for receiving the key signal and the audio signal, the talking mode performed by the talking processor when the talking key pressed and the key signal generated, the receiving mode performed by the talking processor when the talking key released, the talking processor in the talking mode converting the audio signal into the talking signal, and transmitting the talking signal; and
a wireless transceiver electrically connected to the talking processor for receiving the talking signal from the talking processor and transmitting the talking signal received through the exclusive wireless channel when the talking processor operating in the talking mode, or receiving the talking signal from the other walkie-talkies through the exclusive wireless channel and transmitting the talking signal received to the talking processor when the talking processor operating in the receiving mode, the talking processor receiving the talking signal from the wireless transceiver and further transmitting the talking signal received to the audio receiving unit for playing the talking content carried by the talking signal.

8. The method as claimed in claim 6, wherein the determination condition comprises: a silence time during a determination time is within a silence time range of group broadcast, the determination time is not larger than 60 seconds, the silence time refers to a period of time when the talking content is continuously silent, and the silence time range of group broadcast refers to a preset silence time for the communication group, and is within an upper time limit and a lower time limit.

9. The method as claimed in claim 6, wherein the determination condition comprises: a silence number during a determination time is within a silence number range, the determination time is not larger than 30 seconds, the silence number refers to a number as how many times when the talking content is continuously silent and lasts for not less than an effective silence time, the effective silence time is preset between 0.5 and 3 seconds, and the silence number range refers to a broadcast determination number preset for the communication group.

10. The method as claimed in claim 6, wherein the determination condition comprises: the talking content matches a speech identification content through a speech identification process, the determination time is not larger than 30 seconds, the speech identification content comprises a set of key words, and the set of key words comprises at least of a set of broadcast words, a set of group names, and a set of group codes, each of the group names referring to a name of the corresponding communication group, each of the group codes referring to a code of the corresponding communication group.
